(19) United States
(12) Patent Application Publication
(10) Pub. No.: US 2011/0187025 A1
(43) Pub. Date: Aug. 4, 2011

(54) LASER ETCHING SYSTEM AND METHOD

(76) Inventor: Darryl J. COSTIN, SR., Westlake, OH (US)

(21) Appl. No.: 13/021,167

(22) Filed: Feb. 4, 2011

Related U.S. Application Data
(60) Provisional application No. 61/301,406, filed on Feb. 4, 2010.

(51) Int. Cl. B29C 35/08

(52) U.S. Cl. 264/400; 425/174.4

(57) ABSTRACT

A system and method of laser etching materials is provided. A series of optical elements are used to reduce the spot size of a laser for a given field size, allowing fine detailed graphics associated with small spot sizes to be etched with larger field sizes. This may be accomplished, for example, by increasing the size of a laser beam beyond its natural state before passing the beam through a focusing lens, such expander lens, focus lens and mirror system increased in size so as to generate a laser spot size less than or equal to 0.5 mm at a field size equal to or larger than 1500 mm square.

### CROSS-REFERENCE TO RELATED APPLICATIONS

This application claims the benefit of priority of U.S. provisional application 61/301,406, filed on Feb. 4, 2010, the disclosure of which is herein incorporated by reference and to which priority is claimed.

### FIELD OF THE INVENTION

The invention generally relates to a laser-based method and system for etching graphics on materials, and more particularly laser etching large substrates, such as building materials.

### BACKGROUND

Laser etching designs, patterns, and other images is well known for small work pieces such as bearings, glass, cutlery, plastic components, wood plaques, semi-conductors, etc. These products typically have a small working area, requiring a laser having a relatively small field size such as 4-10 inches or less. To provide fine detailed, high resolution images, a laser having a small spot size is required. The detail of an image lazed with a relatively small spot size, for example, less than 0.4 mm would be much finer than the detail of the image lazed with a coarser spot size of 1.2 mm, for example. With the smaller spot size, the laser can etch about 60 lines per inch for near contiguous lines (where the laser lines touch); whereas, with the larger spot size, the laser can etch about 40 laser lines per inch for near contiguous lines. Because laser spot size decreases with field size, high detail, high resolution images can easily be produced on smaller items using a laser with a small field size. Laser etching images on larger work pieces, however, requires a larger field size, which in turn, results in a larger laser spot size and a coarser graphic image. Therefore, fine detail, high resolution graphic images have not been achieved using laser etching over large areas.

The tradeoff between field size and quality of image has prevented larger work pieces from being laser etched in a cost effective manner, especially when the process requires the etching of high resolution images. Some larger materials that would benefit from laser etching include, but are not limited to, interior building products such as flooring, drywall, countertops, bathroom fixtures, kitchen cabinets, interior doors, wall panels, ceiling tiles, and building exterior products such as decking, siding, trim, fencing, windows and exterior doors. These products can be made of gypsum, vinyl, acrylic, hardboard, tempered glass, annealed glass, resin composites, various laminates, veneer, low profile carpet tiles, fiberglass, wood fiber substrates, ceramic, granite, plastic and plastic wood composites, and a variety of other materials.

Laser etching offers an attractive way to decorate products. In order to process large work pieces, manufactures have utilized XY tables where the laser is stationary and the work piece is moved by linear motors in small incremental steps in the X and Y directions. This method, however, severely reduces throughput. It is estimated that a laser using this linear-motor type method takes several minutes per square foot to etch detailed graphic patterns on materials. For example, at this speed, it is estimated that it would take over an hour to laser etch a fine resolution graphic image on a three foot square granite countertop. Thus, the unit manufacturing costs would be far too high to economically process such materials on a mass scale. Because of the inability of prior laser systems to provide a high resolution image over a large field size in a cost effective manner, commercial laser etching of large materials has yet to be realized.

Other methods of decorating large substrates have been tried with unsatisfactory results. Conventional printing technologies such as embossing are limited in graphic design and often produce unappealing aesthetics. Ink-jet printing is very costly. Other processes such as sandblasting have the drawbacks of high cost and poor resolution.

### SUMMARY

A first embodiment comprises a system for laser etching material having a laser for emitting a laser beam. A downstream expander lens increases the size of the emitted laser beam. The beam is then passed through a focusing lens to reduce the spot size of the laser beam. The position of the laser beam is controlled by a set of mirrors.

A method for etching material is provided and comprises emitting a laser beam from a laser source. The diameter of the laser beam is expanded and then passes through a focusing lens. The laser is then scanned over a material to create a design.

Additionally, a method for etching a material is provided where a laser beam is emitted from a laser source. The spot size of the laser beam is reduced from that normally associated with laser of a given field size.

### BRIEF DESCRIPTION OF THE DRAWINGS

FIG. 1 is a schematic view of an exemplary laser system.

FIG. 2 is a schematic view of the optical elements of an exemplary expander lens.

FIG. 3 is a schematic view of an exemplary laser system.

FIG. 4 is a schematic view of an exemplary laser system.

### DETAILED DESCRIPTION OF EXEMPLARY EMBODIMENTS AND EXEMPLARY METHODS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative devices and methods, and illustrative examples shown and described in connection with the exemplary embodiments and methods.

The present invention is directed to a system for laser etching materials. In an exemplary embodiment, the system utilizes a laser combined with a number of optical elements to laser etch a high resolution image on a large substrate, where the laser spot size is less than that normally associated with a given laser field size. The system is capable of providing higher resolution images over larger field sizes than typical laser etching systems. The system also provides a faster throughput than conventional laser systems making laser etching large substrates cost effective, especially in relation to laser etching high resolution images.

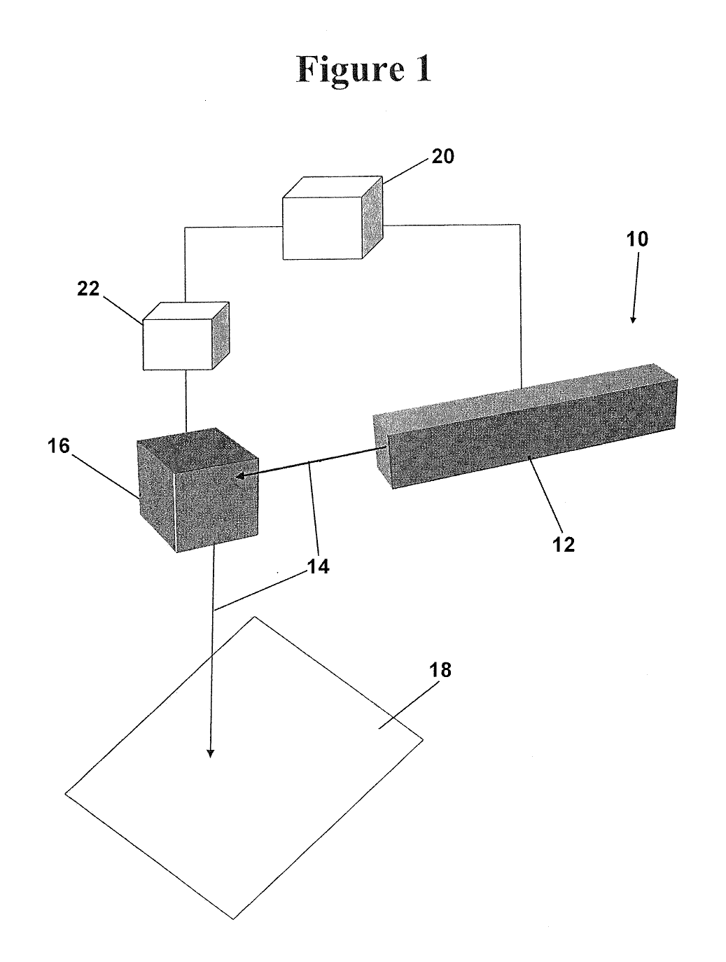

As best shown in FIG. 1, an exemplary embodiment of the system comprises a laser 10 having a housing 12 which emits a laser beam 14. The laser beam 14 then enters a scan head 16. The scan head 16 controls the position of the laser beam 14 and directs it to a substrate 18. A controller 20 is connected to the laser 10 to control the operation and output parameters of the laser. The laser 10 may be any of a variety of types of lasers, for example a CO₂ laser or a yttrium aluminum garnet (YAG) laser. In an exemplary embodiment the laser 10 is capable of operating at a power range between 500-5,000 watts.

The controller 20 may be a computer device such as a numerically controlled computer. The controller 20 should be able to handle a variety of different inputs, including vector graphics and raster graphic images. In certain instances, raster graphics, such as bitmap images, provide an advantage over vector graphics because they allow a more detailed image to be presented. Where vector graphics use mathematically defined elements such as lines, arcs, and fills to approximate an image, raster graphics produce a digital image composed of a matrix of pixels. These pixels are processed by the controller 20 which controls the output parameters of the laser 10 to reproduce the graphic image on a material. More precise likenesses may be etched into a material than with traditional vector graphics created through CAD programs.

The controller 20 may receive process information locally, for example the information may be stored in advance on the controller or input directly by a user. The controller 20 may also be connected to a network which allows information to be sent from a remote location. The process information may be presented on any type of storage medium, such as a hard drive, removable disk, floppy disk or compact disk, and may be presented in a variety of different program languages including C, Java, or Fortran.

The controller 20 is capable of varying a number of parameters of the laser 10 including the power output, the frequency, the duty cycle, the spot size, and the scan speed. The controller 20 is capable of making these changes at high scan speeds. To create fine resolution graphics, the laser power may need to be changed every few millimeters or less during the etching operation. This is especially true when etching an imaged based on a raster graphic. The power must also be adjusted depending on the material and its characteristics. For example, a laser having a continuous power output of 3,000 watts, as distinguished from the power output when the laser has a temporary energy surge or is pulsed, can be varied by lowering or raising the power between 1,000 watts and 3,000 watts during etching.

The controller 20 also adjusts the scan speed of the laser 10. The scan speed is the speed at which the laser beam 14 and the substrate 18 move relative to each other. This speed can be varied by controlling the movement of the laser beam 14, the movement of the substrate 18, or a combination of both. While the system seeks to limit the need to move the substrate 18, it may be necessary in certain situations. For example, a continuous laser-etch on-the-fly printing process moves both the workpiece and the laser beam 14. The workpiece 18 may be moved by a conveyor, a worktable having motors which provide translation from one to six degrees of freedom, or various other methods.

The duty cycle is the portion of time that the laser is turned on during each pulse. Changing the duty cycle controls the amount of power delivered to the substrate 18. For example, power levels between 1,000 and 5,000 watts may be achieved using a single laser simply by controlling the duty cycle.

The power delivered to the substrate 18 may also be changed by adjusting the frequency of the laser 10. The frequency of the laser 10 is the number of emitted pulses per second. Therefore, the higher the frequency, the greater the power transfer to the material.

By controlling the operating parameters of the laser 10, the energy density per unit of time (EDPUT) may be varied. EDPUT is a parameter that defines the amount of power that is applied to a certain area in any unit time. The EDPUT may be expressed in watts-sec/mm³ or other analogous units which express continuous laser power (watts) divided by the speed of movement of the laser times the area of the laser spot (mm³/s). The EDPUT can be controlled by control of laser power, duty cycle, or speed of the laser relative to the work piece for a given power, or by other parameters, and a combination of parameters. The EDPUT can also be controlled by setting a speed of the material relative to the laser, for a given laser power, that will result in a perceivable change for a given laser power. In this sense, the EDPUT is a formulaic way of expressing the amount of energy that is applied to any area of the material, in any time. By controlling the EDPUT, different features may be laser etched into a substrate 18. For example, a pattern resembling wood-grain may be etched on a substrate 18 having realistic changes in color, depth and intensity by varying the EDPUT. See U.S. Pat. No. 5,990,444, entitled Laser Method And System For Scribing Graphics, the disclosure of which is incorporated herein by reference, and which provides a more detailed explanation of EDPUT.

The controller 20 may also be connected to a positioning device 22 which controls the scan head 16. As best shown in FIG. 1, the positioning device 22 is separate from the scan head 16, though it may be incorporated in the same housing. A separate dedicated controller may be used to control the positioning device 22 or the controller 20 may directly control the scan head 16. The positioning device 22 can control the movement of scan head 16 in a variety of ways. Positioning device 22 may utilize a linear motor to move the scan head 16 about an X axis and a Y axis to provide the laser 10 with a larger operable field size. The positioning device 22 may also move the scan head 16 in order to vary the distance between the scan head 16 and the laser housing 12. This not only allows laser etching of larger substrates 18, but also etching of three dimensional objects with a high resolution. The positioning device 20 may also vary the distance between the scan head 16 and the substrate 18. In addition, the positioning device may control optical components in the scan head 16, which position the laser beam 14 over the substrate 18 as discussed in greater detail below.

The scan head 16 is capable of positioning the laser beam 14 over a large field size, for instance a field size of 20 inches or more. In an exemplary embodiment the laser may operate at a field size of 50 inches or more. In order to attain a satisfactory image, however, the spot size of the laser beam 14 must be reduced from what is typical for the associated field size. This is especially true when attempting to laser etch fine detail, high resolution images.

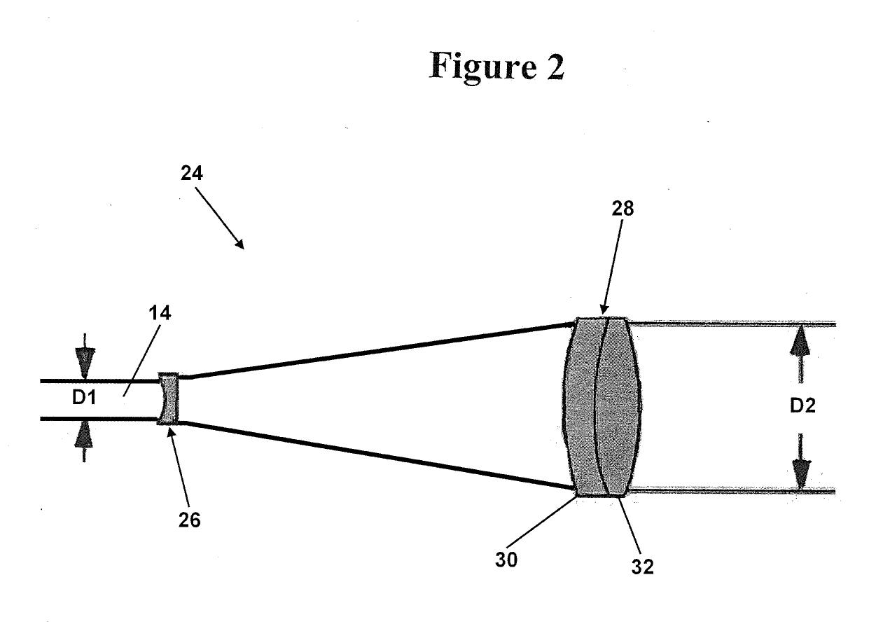

To achieve a smaller spot size, the laser beam 14 first passes through one or more expander lenses. The expander lens 24 may be located within the laser housing 12, the scan head 16, or it may be separate from the laser. Additionally, the position of the expander lens 24 may be fixed or variable. As best shown in FIG. 2, the expander lens 24 may be of the Galilean type, comprising a first lens 26 having a negative focal length and a second lens 28 having a positive focal length. In an exemplary embodiment, the first lens 26 is a plano concave lens and the second lens 28 is an achromatic lens. The achromatic lens may be of the doublet type, having a concave lens 30 and a convex lens 32 positioned together. A variety of different optical elements may be used to create the expander lens 24 so that the optical elements may differ from that shown in FIG. 2 and still fall within the scope of the present invention. For example, a Keplerian beam expander arrangement may be used.

The laser beam 14, having an initial diameter D1, enters the first lens 26. After passing through the first lens 26 the laser beam 14 diverges, growing in diameter. As the laser beam 14 passes through the second lens 28, the divergence of the beam 14 is reduced so that it will retain a constant diameter D2. The amount the beam 14 diverges depends on the characteristics of the lenses 26, 30, 32, and the distance between each lens. As noted above, the field size of the laser 10 is directly related to the diameter of the laser beam. Thus, the field size of the laser 10 may be adjusted by adjusting the expander lens 24.

In an exemplary embodiment, the lenses 26, 28 used in the expander lens 24 will have at least one dimension of 0.5 inches or greater, possibly between 0.5 inches and 6.5 inches. The dimension will be dependent on the shape of the lenses 26, 28 so that it may be a diameter for a circular lens, a length or height for polygon lens, the length of a major or minor axis for an elliptical lens, etc.

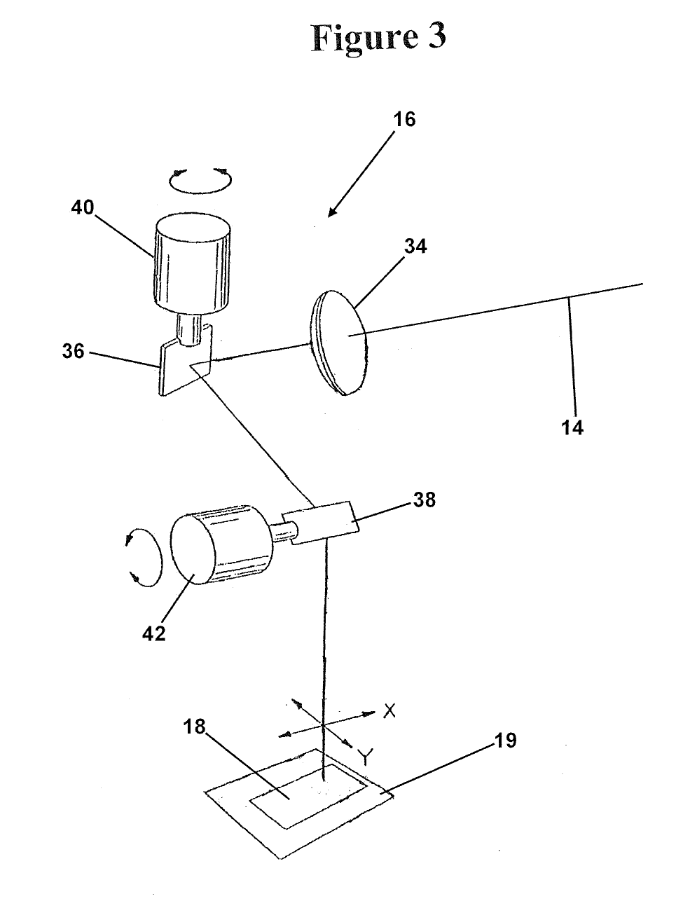

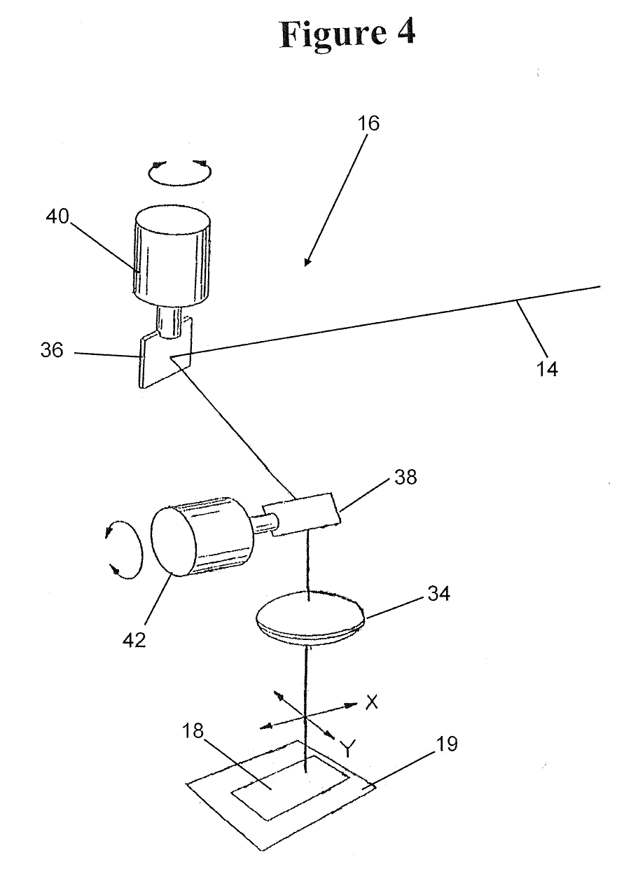

After passing through the expander lens 24 and being emitted from the housing 12, the laser beam 14 enters the scan head 16. As best shown in FIGS. 3 and 4, the scan head 16 comprises a number of optical elements which allow the laser beam 14 to be scanned across a substrate 18. In an exemplary embodiment, the scan head 16 comprises a lens 34, an X-axis mirror 36 and a Y-axis mirror 38. The system also includes a working surface 19 for supporting the substrate 18. A variety of types of working surfaces 19 may be used to support a substrate 18. The working surface 19 may be a solid surface or a fluidized bed. It may also be a stationary platform or a moveable system such as a conveyor belt.

The objective lens 34 reduces the spot size of the laser, providing high resolution. In an exemplary embodiment, the lens 34 is a focusing lens and may be a multi-element flat-field focusing lens assembly. While a single expander lens 24 and focusing lens 34 are shown and described, multiple lenses may be used to achieve a small spot size at the work piece. Using a combination of an expander lens 24 and a focusing lens 34 in this way achieves a small spot size in a system while maintaining a relatively large field size.

The focusing lens 34 may have at least one dimension of 0.5 inches or greater, possibly between 0.5 inches and 6.5 inches. The dimension will be dependent on the shape of the lenses 26, 28 so that it may be a diameter for a circular lens, a length or height for polygon lens, the length of a major or minor axis for an elliptical lens, etc. The dimensions and shape of the focusing lens 34 and the expander lens 24 may be the same or they may vary, depending on the initial parameters of the laser and the final desired output.

Typically, lasers operating with a large field size use long focal length lenses. The spot size of the laser beam 14 is directly proportional to the focal length, so that long focal length lenses will create a relatively large spot size. The laser spot size decreases the resolution or quality of the image etched into a substrate 18. To overcome this problem, the expander lens 24 of the present invention increases the size of the laser beam 14. In certain cases, multiple expander lenses 24 are used to accomplish this. It has been found that the larger the beam diameter entering the focusing lens 34, the smaller the spot size will be. Therefore, by passing the laser beam through an expander lens 24, the focusing lens 34 may be used to give the laser 10 a relatively large field size while keeping the spot size of the laser beam 14 small enough to produce high resolution images normally associated with smaller field size lasers.

The spot size normally associated with a 20 inch laser field size may be achieved with a laser having a 40 to 60 inch field size by practicing the teachings of this invention. For example, the spot size at the work piece for a laser having a 20 inch field is about 0.4 mm. The spot size at the work piece for a laser having a 40 inch field may be about 0.8 mm, and the spot size at the work piece for a laser having a 60 inch field may be about 1.2 mm. Therefore, by practicing the teachings of this invention, laser spot sizes at the work piece less than 0.4 mm may be uniquely achieved for 40 inch and even 60 inch laser field sizes.

A variety of different optics and setups may be used to achieve the optimal operating parameters for a given substrate. For instance, by utilizing different focal lengths and diameters for the lens 34, utilizing different size expander lenses 24, varying the distance between the expander lens 24 and the lens 34, and using multiple optical lenses, different spot sizes and field sizes may be achieved. Additionally, the type of laser used can affect the spot size of the laser 10. Because the spot size of a laser is directly proportional to its wavelength, spot size may be reduced by operating at a lower wavelength. For example, a YAG laser typically operates at 1/10 of the wavelength of a CO₂ laser.

In order to process the large laser beam width, a large diameter lens 34 should be used. Additionally, depending on the set-up, relatively large X and Y axis scanning mirrors 36, 38 may also need to be used. The mirrors 36, 38 may have at least one dimension greater than 1 inch, for example between 1 inch and 10 inches. The size of the mirrors may vary depending on the size of the expander lens 24 and the focusing lens 34, so that the greater the size of the lenses 24, 34, the greater the size of the mirrors 36, 38. By utilizing such a large lens and mirror system, small laser spot sizes can be achieved and correspondingly fine resolution graphic images can be etched on large workpieces. For example, fine detailed wood grain patterns can be etched on four-foot wide doors in a single operation.

As best shown in FIGS. 3 and 4, the position of the laser beam 14 may be controlled by mirrors 36, 38. The X-axis mirror 36 is rotatably mounted on and driven by an X-axis galvanometer 40. The X-axis galvanometer 40 rotates the X-axis mirror 36. Rotation of the X-axis mirror 36 while the laser beam 14 is incident on the mirror 36 causes the laser beam 14 to move along the X-axis. As mentioned above, the movement of the X-axis mirror 36 may be controlled by the positioning device 22 or it may be directly connected to the controller 20. In an exemplary embodiment the positioning device 22 receives information from the controller 20 to control rotation of the X-axis galvanometer 40.

The laser beam 14 is deflected by the X-axis mirror 36 and directed toward the Y-axis mirror 38 rotatably mounted on Y-axis galvanometer 42. The Y-axis galvanometer 42 rotates the Y-axis mirror 38 which causes movement of the laser beam 14 incident on mirror 38 along the Y-axis. The positioning device 22 receives information from the controller 20 to control rotation of the Y-axis galvanometer 42. In addition to controlling the etching by moving the laser beam 14, the substrate 18 may be moved and the laser beam 14 held stationary, or both maybe be moved in different directions and/or at different speeds.

After deflecting off the Y-axis mirror 38, the laser beam 14 is directed to the working surface 19 and thus onto the substrate 18. Usually the laser beam 14 is directed generally perpendicular to the surface of the substrate 18, but different graphics can be achieved by adjusting the angle between the laser beam 14 and the substrate 18, for instance from 45 degrees to about 135 degrees. For example, when laser etching a wood grain pattern, the laser beam 14 can be angled relative to the substrate 18 to etch an angled notch in the wood, simulating natural wood knots.

A variety of optical elements and configurations may be used in practicing the present invention. The laser beam may be first directed towards the Y-axis mirror 38 and then incident to the X-axis mirror 36. As shown in FIGS. 3 and 4, the lens 34 may be placed either before or after the mirror system. Additionally, the mirrors 36, 38 may be coated with a high temperature coating such as achieved with a physical vapor deposited alloy. This coating allows the mirrors 36, 38 to reflect over 98% of a CO₂ laser at a wavelength of 10.6 microns. Different optics and lenses such as objective lenses, expander lenses, concave lenses, convex lenses, focusing lenses, cylindrical lenses, mirrors, splitters, combiners, or reflectors, etc., can be introduced either before or after the mirrors. The addition of these optics can be used to adjust the properties of the laser and the parameters of the etching operation, as needed for each application.

In certain procedures, the use of relatively large mirrors 36, 38 may cause problems with the ability to obtain a good quality laser etched image in specific areas where the mirrors 36, 38 would have to start up, change direction, or stop to etch a graphic. In these instances, the controller implements a procedure to overcome this deficiency by utilizing software which creates boundaries just before and just after each line. Operating parameters of the laser are set so that the first segment of a line and the last segment of the line will be invisible, for example by delivering insufficient power to etch the material with a distinguishing mark. Thus, the startup and shut down power of the laser can be controlled to deliver smooth etching results at high speeds even with large relatively heavy mirrors which are more difficult to precisely start and stop.

Lasers with large field sizes demand the use of long focal length lenses that results in large focused laser spot sizes. For example, laser spot sizes of 1-2 mm would typically be associated with a 1500 mm square laser field size.

This invention discloses an optic system that is composed of larger lenses and mirrors so as to achieve focused laser spot sizes less than the laser spot size associated with the specific field size. For example, one embodiment of this invention it to use lenses and mirrors that are 25% to 500% larger than those associated with the 1500 mm square laser field size so as to create a laser spot size equal to or less than 0.5 mm.

The functionality of the expander lens is to increase the laser beam diameter since the larger the diameter of the laser beam that enters the focus lens, the smaller the spot size. Larger focus lens and mirror systems will be required to achieve the invention of laser spot size less than or equal to 0.5 mm for a 1500 mm laser field size.

The functionality of the focus lens is to accept the laser beam and narrow it to a much finer size. A larger focus lens would be required to accept a larger beam diameter and reduce it to the small size.

The functionality of the mirror system is to direct the laser beam to the work piece and scan the laser beam across the work piece along a predetermined path. In the case of pre objective scanning architecture as shown in FIG. 4, the scan head and mirrors are located before the focus lens in the beam path. In case of post objective scanning architecture as shown in FIG. 3, the scan head and mirrors are located after the focus lens in the beam path. In either case, larger mirrors would be required to accept the laser beam with a smaller spot size.

By utilizing the described apparatus and method, the field size and the spot size of the laser 10 may be adjusted. In this way, different size substrates may be processed and different levels of resolution and detail may be provided using the same system. This capability allows the laser and minor system parameters to be optimized for different operations without shutdown of the equipment or manual adjustment by an operator. Changing the field size and the spot size can be accomplished through a number of different ways. For example, varying the position of the scan head 16 both with respect to the laser housing 12 and the substrate 18 varies the field size and the spot size. Additionally, varying the properties of the expander lens 24 and lens 34 as discussed above will affect the spot size and the field size of the laser 10.

The laser system may utilize more than one laser 10 to process different sections of the substrate 18. The lasers 10 are programmed to produce a substantially perfect pattern seam between the areas where the lasers 10 etch the material. This can be used to etch objects over a larger area or to provide a higher resolution image to an object by reducing the required field size. Alternatively, a beam splitter may be used so each beam processes a section of a substrate 18.

The laser system described above can be used to perform a wide variety of operations on a number of different materials. Any material which can be laser etched will benefit from the present invention which provides a higher resolution and finer detail at a faster throughput over a larger field size than traditional laser systems. For example, laser etching may be performed on large glass pieces used in residential and commercial buildings. Large workpieces may be etched to provide high resolution patterns and graphics of different designs. Laser etching fine resolution images or perforations on leather or cloth parts, such as automobile interiors, can also be improved. For instance, instead of laser etching one leather seat part at a time, several seat parts can be laser etched at once.

The present invention may also be used to provide a higher throughput of small workpieces than with typical laser systems. A number of smaller substrates, such as 6 inch decking substrates, may be placed together on a worktable and etched in the same operation. Where typically only three of such substrates could be processed at the same time with a laser having a 20 inch field size, the present invention allows up to nine 6 inch substrates to be formed with a 60 inch field size having the same spot size and resolution that is typically achieved with a 20 inch field size.

The present invention is also advantageous over traditional methods because it allows for laser etching large substrates with a minimum joining of etched parts. Traditional laser systems require separate sections to be laser etched at separate times. This can create demarcations or defects in the pattern or image at the boundary regions where the separate sections meet. The present invention eliminates or minimizes the problems associated with visual defects at the joints of such sections because fewer joints, if any, will be required. For example, a laser having a 60 inch field can etch one sixty inch pattern with a small spot size, versus using a 20 inch field that etches three twenty inch patterns.

The foregoing description of the exemplary embodiments of the present invention has been presented for the purpose of illustration. It is not intended to be exhaustive or to limit the invention to the precise forms disclosed. Obvious modifications or variations are possible in light of the above teachings. The embodiments disclosed hereinabove were chosen in order to best illustrate the principles of the present invention and its practical application to thereby enable those of ordinary skill in the art to best utilize the invention in various embodiments and with various modifications as are suited to the particular use contemplated, as long as the principles described herein are followed. Thus, changes can be made in the above-described invention without departing from the intent and scope thereof. Moreover, features or components of one embodiment may be provided in another embodiment. Thus, the present invention is intended to cover all such modification and variations.

What is claimed:

1. A system for laser etching materials comprising:
a laser source for emitting a laser beam;
an expander lenses;
a focusing lens;
a first minor directing the movement of the laser beam in a first direction; and
a second minor directing the movement of the laser beam in a second direction, wherein said expander lens, focus lens and minors are increased in size so as to generate a laser spot size less than or equal to 0.5 mm at a field size equal to or larger than 1500 mm square.

2. A system for laser etching materials according to claim 1, wherein the expander lens is incorporated within a laser housing.

3. A system for etching materials according to claim 2, wherein the laser beam passes through the expander lenses and focusing lens before reaching the first and second minors.

4. A system for etching materials according to claim 1, wherein said focusing lens is immediately downstream of said expander lens.

5. A system for etching materials according to claim 4, wherein a laser beam emitted from said laser source has a first initial field size corresponding to a first initial spot size and the laser beam after passing through the focusing lens has a second spot size smaller than said first spot size while maintaining said initial field size.

6. A system for etching materials according to claim 3, wherein the distance between the focusing lens and the laser source can be varied.

7. A system for etching materials according to claim 1, wherein the field size of the laser is greater than 20 inches.

8. A system for etching materials according to claim 1, wherein the field size of the laser is greater than 40 inches.

9. A system for etching materials according to claim 1, wherein the laser beam has a scan speed greater than 10 m/s.

10. A system for etching materials according to claim 1, further comprising more than one expander lens.

11. A method for etching material comprising:
emitting a laser beam from a laser source;
expanding the diameter of said laser beam;
passing the laser beam through a focusing lens such laser spot size less than or equal to 0.5 mm at a field size equal to or larger than 1500 mm square is generated; and
scanning the laser beam over a material to create a design.

12. The method for etching material according to claim 11, wherein the diameter of the laser beam is expanded by an expander lens.

13. The method for etching material according to claim 12, wherein the expander lens is incorporated into a housing containing the laser source.

14. The method for etching material according to claim 13, wherein the housing is moveable relative to the focusing lens.

15. The method for etching material according to claim 14, wherein the distance between the focusing lens and the expander lens is sufficient to obtain a spot size less than the native spot size for a laser having a given field size.

16. The method for etching material according to claim 11, further comprising providing a first mirror for controlling the movement of the laser beam in the X direction and a second mirror for controlling the movement of the laser beam in the Y direction.

17. The method for etching material according to claim 11, further comprising the step of using computer control to create boundaries before and after a line to be etched.

18. The method for etching a material according to claim 11, wherein the field size of the laser is greater than 20 inches.

19. The method for etching a material according to claim 11, wherein the field size and the spot size of the laser can be adjusted.

20. The method for etching a material according to claim 11, wherein the material comprises a wood composite and the design comprises a wood grain pattern.

21. The method for etching a material according to claim 11, wherein the material is selected from granite, glass, or leather.

22. The method for etching material according to claim 11, wherein the diameter of the laser beam is expanded using more than on expander lens.

23. A method for etching a material comprising:
emitting a laser beam from a laser source having a given field size, the laser beam having an initial spot size; and
reducing the spot size of the laser beam while at least maintaining the field size.

24. The method according to claim 23, wherein the reduced laser spot size is achieved by increasing the diameter of the laser beam with at least one expander lens, and then subsequently passing the laser beam through at least one focusing lens.

25. The method for etching material according to claim 23, wherein the distance between the focusing lens and the expander lens and the size and number of each is optimized to obtain a spot size less than the native spot size available for a given field size.

26. The method for etching a material according to claim 23, wherein the field size of the laser is greater than 30 inches but the spot size is no greater than that for a laser having a 20 inch field size.

27. The method for etching a material according to claim 23, wherein the field size of the laser is greater than 50 inches but the spot size is no greater than that for a laser having a 30 inch field size.
